(19) United States
(12) Patent Application Publication
(10) Pub. No.: US 2007/0016606 A1
(43) Pub. Date: Jan. 18, 2007

(54) Method of analysing representations of separation patterns

(76) Inventors: Ian Morns, Tyne & Wear (GB); Anna Kapferer, Newcastle upon Tyne (GB); David Bramwell, Newcastle Upon Tyne (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 11/212,479

(22) Filed: Aug. 26, 2005

(30) Foreign Application Priority Data
Jul. 15, 2005 (GB) 0514552.9

(51) Int. Cl. G06F 7/00

(52) U.S. Cl. 707/102

(57) ABSTRACT

The present invention relates principally to the statistical analysis of protein separation patterns. The invention provides a method of analysing representations of separation patterns, the method comprising iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

### CROSS-REFERENCES TO RELATED APPLICATIONS

This application claims the benefit of United Kingdom Application Serial Number 0514552.9, filed Jul. 15, 2005, which application is incorporated herein by reference.

This application is related to Attorney Docket No. 2233.002US1, titled: A METHOD OF ANALYSING SEPARATION PATTERNS, U.S. application Ser. No. ______; and Attorney Docket No. 2233.003US1, titled: A METHOD OF ANALYSING A REPRESENTATION OF A SEPARATION PATTERN, U.S. application Ser. No. ______, both of which are filed on even date herewith and incorporated by reference

### FIELD OF THE INVENTION

The present invention relates principally to the statistical analysis of protein separation patterns.

### BACKGROUND OF THE INVENTION

A large proportion of supervised learning algorithms suffer from having large numbers of variables in comparison to the number of class examples. With such a high ratio, it is often possible to build a classification model that has perfect discrimination performance, but the properties of the model may be undesirable in that it lacks generality, and that it is far too complex (given the task) and very difficult to examine for important factors.

It is desirable to overcome some or all of the above-described problems.

### SUMMARY OF THE INVENTION

According to a first aspect of the invention, there is provided a method of performing operations on protein samples for the analysis of representations of separation patterns, the method comprising iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

By “representation” is meant any image, vector, table, database, or other collection of data representing a separation pattern. The data may have any dimensionality. By “separation pattern” is meant the result of any separation technique, including, but not limited to, gel electrophoresis, mass spectrometry, liquid chromatography, affinity binding, and capillary electrophoresis.

By “data point” is meant any constituent unit of data in the representation.

For example, in one embodiment, the representation is a two-dimensional image of a separation pattern obtained by gel electrophoresis, each pixel of the image constituting a data point.

It is known that the representations contain highly correlated data points and that some of the data points are not predictive of class. It is important that some models are not perfect, so that it may become apparent which areas of a separation pattern are important. Reducing the number of data points used in the classification procedure, by building models from random subsets of the original data, produces a range of classification performances. In the cases where the subset contains very few or no data points that are predictive of class, near chance performance is obtained. As more and more data points are included that are highly predictive, the discrimination results improve.

The invention provides a method of deriving the optimal number of data points to place within a subset in order to produce the expected range of performance values which allows models to be produced whose dimension is closer to that required to make the classification than to the original data dimensions.

For example, if there are 100 variables per class, it may be that a high performance model can be built using just 7 of these. Then, only a 7-dimensional model is needed, and not a 100-dimensional one. The other 93 variables may be very important for other reasons, but only 7 are needed for the classification at hand. This also produces improvements in the generality of fitted models.

The optimal number of data points depends on the goals of the analysis. In certain instances, slightly lower dimension is preferred to perfect performance. In other instances, perfect performance is preferred at the possible cost of slightly higher dimensionality.

By restricting the number of data points serving as input variables used to build a model, the model is more likely to fail. This is desirable if perfect performance is to be avoided.

In a preferred embodiment, during each iteration, steps (1) and (2) are repeated for subsets of uniform size but including different data points to obtain a distribution of model performances.

Step (2) may include determining whether a mean performance of the distribution is within the desired range.

Step (3) may include reducing the size of the subset if the mean performance is between a higher end of the desired range and perfect performance. Step (3) may include increasing the size of the subset if the mean performance is below a lower end of the desired range.

In the preferred embodiment, the desired range is from about 2.5 to about 3.0 standard deviations below perfect performance.

During the first iteration, step (1) may include arbitrarily selecting the size of the subset.

In step (1), the data points forming the subset may be selected randomly.

According to a second aspect of the invention, there is provided a method of analysing representations of separation patterns, the method comprising iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

The method of the second aspect of the invention may include any feature of the method of the first aspect of the invention.

According to the first aspect of the invention, there is provided apparatus for performing operations on protein samples for the analysis of representations of separation patterns, the apparatus comprising means for iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

According to the second aspect of the invention, there is also provided apparatus for analysing representations of separation patterns, the apparatus comprising means for iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

According to the invention, there is also provided a computer program directly loadable into the internal memory of a digital computer, comprising software code portions for performing a method of the invention when said program is run on the digital computer.

According to the invention, there is also provided a computer program product directly loadable into the internal memory of a digital computer, comprising software code portions for performing a method of the invention when said product is run on the digital computer.

According to the invention, there is also provided a carrier, which may comprise electronic signals, for a computer program of the invention.

According to the invention, there is also provided electronic distribution of a computer program or a computer program product or a carrier of the invention.

### BRIEF DESCRIPTION OF THE DRAWINGS

In order that the invention may more readily be understood, a description is now given, by way of example only, reference being made to the accompanying drawings, in which:—

FIG. 1 is a flowchart representing a method according to the invention;

FIG. 2 is a schematic diagram of a software implementation according to the invention.

### DETAILED DESCRIPTION OF THE INVENTION

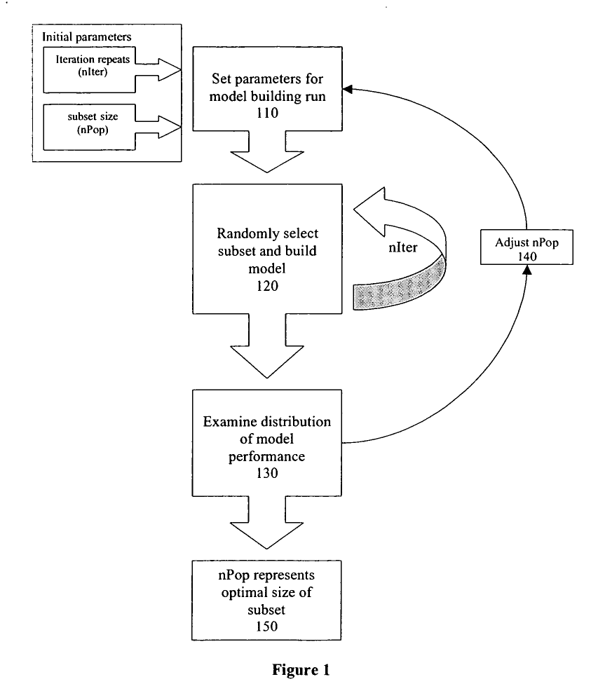

FIG. 1 is a flowchart representing a method of subset size determination according to the invention.

In step 110, initial values for the number of data points in a subset, nPop, and the number of iterations, nIter, for the model-building step (step 120) are arbitrarily selected.

Typically, the initial values effect how long the process takes to optimise, more than whether the optimisation works or not.

In step 120, a number nPop of data points from one or more representations are randomly selected to form a subset. The subset is partitioned into a training set and a test set, and a classification model is built based on the training set. This step is repeated niter times, each time using a subset including nPop randomly-selected data points.

In step 130, the performance of each model is assessed, using the test set associated with each model, and a distribution of model performances is produced. A mean performance value and the standard deviation of the distribution are then calculated, before it is determined whether the mean performance falls within a desired range, which in this embodiment is from about 2.5 to about 3.0 standard deviations below perfect performance.

If the mean performance falls outside of the desired range, the process proceeds to step 140, and then back to step 110. In step 140, if the mean performance is less than about 2.5 standard deviations below perfect performance, nPop is reduced. If the mean performance is more than about 3.0 standard deviations below perfect performance, nPop is increased.

If the mean performance falls within the desired range, the current value of nPop is taken as the optimal subset size, in step 150.

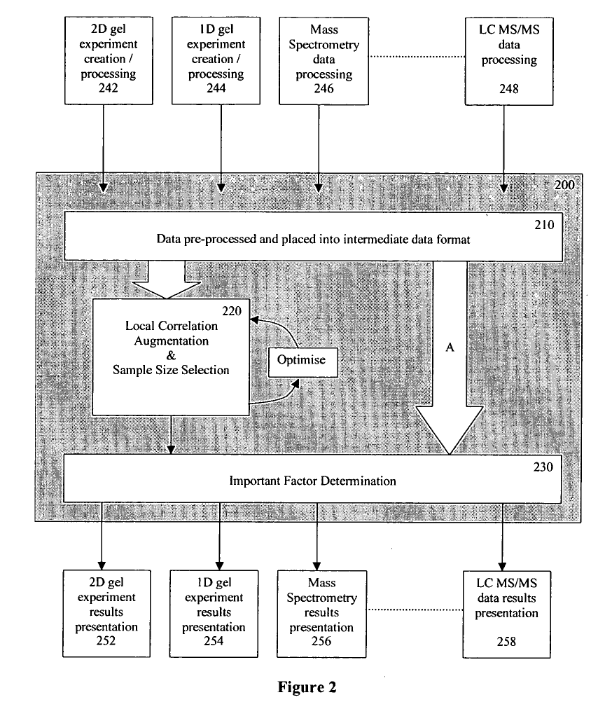

FIG. 2 is a schematic diagram of a software implementation 200 according to the invention.

The software implementation 200 is a generic automated analysis block that operates on supervised data across modalities, i.e. it is not specific to 2D gels, 1D gels, or mass spectra, for example.

In a preferred embodiment, the software implementation is incorporated into multi-application computer software for running on standard PC hardware under Microsoft® Windows®. However, it is to be understood that the invention is platform independent and is not limited to any particular form of computer hardware.

The software implementation 200 includes a data preprocessing block 210; a local correlation augmentation and subset size determination block 220, for performing the method of the invention; and an important factor determination block 230, which produces an importance map.

The software implementation 200 receives input data from one of a number of input blocks 240, each input block 240 representing a different separation technique. FIG. 2 shows exemplary input blocks designated 242, 244, 246 and 248.

The input data is in the form of several vectors, each having a class label. Each vector includes a number of 16-bit integer or double precision floating point numbers. The input blocks 240 create a uniform format from the diverse formats of data obtained using the various separation techniques. In addition, there is a secondary metadata file that includes a description of the original data format.

In this embodiment, only one input block is used at a time. In a variant, more than one input block is used simultaneously.

Metadata, including class information, is passed directly from the data preprocessing block 210 to the important factor determination block 230, as indicated by arrow A.

The software implementation 200 sends output data to a number of output blocks 250. FIG. 2 shows exemplary output blocks designated 252, 254, 256 and 258. Each output block 250 corresponds to an input block 240.

The output blocks 250 receive results in a generic form and map the results to a more accessible form, for example an image or trace. In block 252, the importance map is mapped back onto one of the images from the set. In block 254, the importance map is mapped back to a gel image; in block 256 to a trace; and in block 258 to a 2D representation of the LC MS data.

The importance map can be used to identify regions of a separation pattern which are important in predicting a classification of the separation pattern. Its construction involves repeatedly building classification models and assessing their performance.

The method of the invention reduces the dimensionality of the data on which those classification models are built.

When the software implementation 200 is commercially exploited, the input blocks 240 and output blocks 250 are tailored to the user's specific requirements, which distinction is transparent to the user.

It is to be understood that, while examples of the invention have been described involving software, the invention is equally suitable for being implemented in hardware, or any combination of hardware and software.

Some portions of the preceding description are presented in terms of algorithms and symbolic representations of operations on data bits within a machine, such as computer memory. These algorithmic descriptions and representations are the ways used by those skilled in the data processing arts to most effectively convey the substance of their work to others skilled in the art. An algorithm includes a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

There is also provided electronic distribution of a computer program of or a computer program product or a carrier of the invention. Electronic distribution includes transmission of the instructions through any electronic means such as global computer networks, such as the world wide web, Internet, etc. Other electronic transmission means includes local area networks, wide area networks. The electronic distribution may further include optical transmission and/or storage. Electronic distribution may further include wireless transmission. It will be recognized that these transmission means are not exhaustive and other devices may be used to transmit the data and instructions described herein.

1. A method of performing operations on protein samples for the analysis of representations of separation patterns, the method comprising iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

2. The method of claim 1 wherein, during each iteration, steps (1) and (2) are repeated for subsets of uniform size but including different data points to obtain a distribution of model performances.

3. The method of claim 1 wherein step (2) includes determining whether a mean performance of the distribution is within the desired range.

4. The method of claim 1 wherein step (3) includes reducing the size of the subset if the mean performance is between a higher end of the desired range and perfect performance.

5. The method of claim 1 wherein step (3) includes increasing the size of the subset if the mean performance is below a lower end of the desired range.

6. The method of claim 1 wherein the desired range is from about 2.5 to about 3.0 standard deviations below perfect performance.

7. The method of claim 1 wherein, during the first iteration, step (1) includes arbitrarily selecting the size of the subset.

8. The method of claim 1 wherein, in step (1), the data points forming the subset are selected randomly.

9. A method of analysing representations of separation patterns, the method comprising iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

10. Apparatus for performing operations on protein samples for the analysis of representations of separation patterns, the apparatus comprising means for iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

11. Apparatus for analysing representations of separation patterns, the apparatus comprising means for iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.

12. A computer program directly loadable into the internal memory of a digital computer, comprising software code portions for performing the method of claim 1 when said program is run on the digital computer.

13. A computer program product directly loadable into the internal memory of a digital computer, comprising software code portions for performing the method of claim 1 when said product is run on the digital computer.

14. A carrier, which may comprise electronic signals, for a computer program of claim 13.

15. Electronic distribution of a computer program of claim 13.

16. A computer-readable medium having computer executable instructions for performing a method of performing operations on protein samples for the analysis of representations of separation patterns, the method comprising iteratively performing the steps of (1) building a classification model based on a subset of data points selected from one or more representations, (2) assessing the performance of the model to determine whether its performance is within a desired range, and (3) adjusting the size of the subset until the performance of the model falls within the desired range.
